(19) United States
(12) Patent Application Publication
(10) Pub. No.: US 2014/0007260 A1
(43) Pub. Date: Jan. 2, 2014

(54) File Reading Protection System and a Protection Method Thereof

(71) Applicant: O2Micro, Inc., Santa Clara, CA (US)

(72) Inventors: Sterling Shyundii Du, Shanghai (CN); Jingjing Zuo, Beijing (CN); Chengxia He, Chengdu (CN)

(21) Appl. No.: 13/924,261

(22) Filed: Jun. 21, 2013

(30) Foreign Application Priority Data
Jun. 29, 2012 (CN) 201210220529.5

(51) Int. Cl. G06F 21/62

(52) U.S. Cl. CPC G06F 21/6209
USPC 726/28

(57) ABSTRACT

A file reading protection system and a protection method thereof. The file reading protection system includes a first acquisition unit, a determination unit, and a processing unit. The first acquisition unit is configured to obtain a first position of a user device that requests to access a digital file. The determination unit is configured to determine if the first position obtained by the first acquisition unit satisfies a first predetermined condition related to the predetermined position information and to generate a determination result according determination. The processing unit is configured to determine if the user is allowed to access the digital file according to the determination result.

### RELATED APPLICATIONS

This application claims priority to Patent Application Number 201210220529.5, filed on Jun. 29, 2012 with the State Intellectual Property Office of the P.R. China (SIPO), the specification of which is incorporated herein by reference in its entirety.

### FIELD OF THE INVENTION

The present invention relates generally to the field of reading digital files, and specifically, the present invention relates to a file reading protection system for protecting the digital files from being read by people who are not authorized and a method for protecting the digital files thereby.

### BACKGROUND

Different format of digital files are used by people during development of electronic and digital technology. For example, digital files including various formats, such as words, images, audio, and video, can be conference reports, presentation documents, courseware, etc. The digital files may be stored in media by the owner (for example, a file's author or a file's owner), especially the digital files may be stored in the media that are integrated in mobile devices, such as U-disks, removable disks, notebook computers, and mobile phones, etc. The digital files may be copied and accessed frequently by a user, however, due to the diversity of the transmission path and transmission mode, the digital files may also be accessed and used by people who are not authorized to read or use.

For example, if a presentation document is copied onto a device in a meeting place for presentation by the owner, after the presentation, the presentation document in the device should be removed. But often the owner forgets to do so, then the presentation document may be copied and used by others who are not authorized to read or use the presentation document.

As the digital files may be copied and accessed frequently, and the digital files may be transferred through multiple media, for example, internet, etc, the digital files may be obtained and used by people who are not authorized. So there is a need to solve the above-mentioned problem.

### SUMMARY

In one embodiment, a file reading protection system for protecting a digital file is disclosed. The file reading protection system includes a first acquisition unit, a determination unit, and a processing unit. The first acquisition unit is configured to obtain a first position of a user device that requests to access a digital file. The determination unit is configured to determine if the first position obtained by the first acquisition unit satisfies a first predetermined condition related to the predetermined position information and to generate a determination result according determination. The processing unit is configured to determine if the user is allowed to access the digital file according to the determination result.

In another embodiment, a method for performing file reading protection is disclosed. the method includes the steps of obtaining a first position of a user device that requests to access a digital file by a first acquisition unit; determining if the first position obtained by the first acquisition unit satisfies a first predetermined condition related to the predetermined position information by a determination unit and generating a determination result according determination; and determining if the user is allowed to access the digital file according to the determination result by a processing unit.

### BRIEF DESCRIPTION OF THE DRAWINGS

Features and advantages of embodiments of the claimed present invention will become apparent as the following detailed description proceeds, and upon reference to the drawings, wherein like numerals depict like parts. These exemplary embodiments are described in detail with reference to the drawings. These embodiments are non-limiting exemplary embodiments, in which like reference numerals represent similar structures throughout the several views of the drawings.

FIG. 1 is a block diagram illustrating an example of a file reading protection system, in accordance with one embodiment of the present disclosure;

FIG. 2 is a block diagram illustrating another example of a file reading protection system, in accordance with one embodiment of the present disclosure;

FIG. 3 shows an example of a detailed block diagram of a second acquisition unit in FIG. 2;

FIG. 4 shows another example of a detailed block diagram of the second acquisition unit in FIG. 2;

FIG. 5 is a flowchart illustrating an exemplary of a method for performing file reading protection, in accordance with one embodiment of the present disclosure; and

FIG. 6 is a flowchart illustrating another exemplary of a method for performing file reading protection, in accordance with one embodiment of the present disclosure.

### DETAILED DESCRIPTION

Reference will now be made in detail to the embodiments of the present teaching. While the present teaching will be described in conjunction with these embodiments, it will be understood that they are not intended to limit the present teaching to these embodiments. On the contrary, the present teaching is intended to cover alternatives, modifications and equivalents, which may be included within the spirit and scope of the present teaching as defined by the appended claims.

Furthermore, in the following detailed description of the present teaching, numerous specific details are set forth in order to provide a thorough understanding of the present teaching. However, it will be recognized by one of ordinary skill in the art that the present teaching may be practiced without these specific details. In other instances, well known methods, procedures, components, and circuits have not been described in detail as not to unnecessarily obscure aspects of the present teaching.

The present invention provides a file reading protection system that enables an owner to encrypt a file according to geographic coordinates of a specific location and also to designate that the file can be accessed by other users when the encrypted file is at a specifically designated location. When the encrypted file is at the designated location, the encrypted file can be accessed; when the encrypted file is moved to another location that not approved by the owner, the encrypted file cannot be accessed. Specifically, the file reading protection system includes a first acquisition unit, a determination unit, and a processing unit. The first acquisition unit is configured to obtain a position of a user device that made a reading request of a digital file, wherein the digital file is encrypted by using designated location related to a geographical position of an owner of the digital file. The determination unit is configured to determine if the position of the user device obtained by the first acquisition unit satisfies a predetermined location for the user device and if the position does satisfy the predetermined location, then a determination result is generated according determination, wherein the predetermined location for the user device relates to the location designated by the owner. The processing unit is configured to determine if the user is allowed to access the digital file according to the determination result.

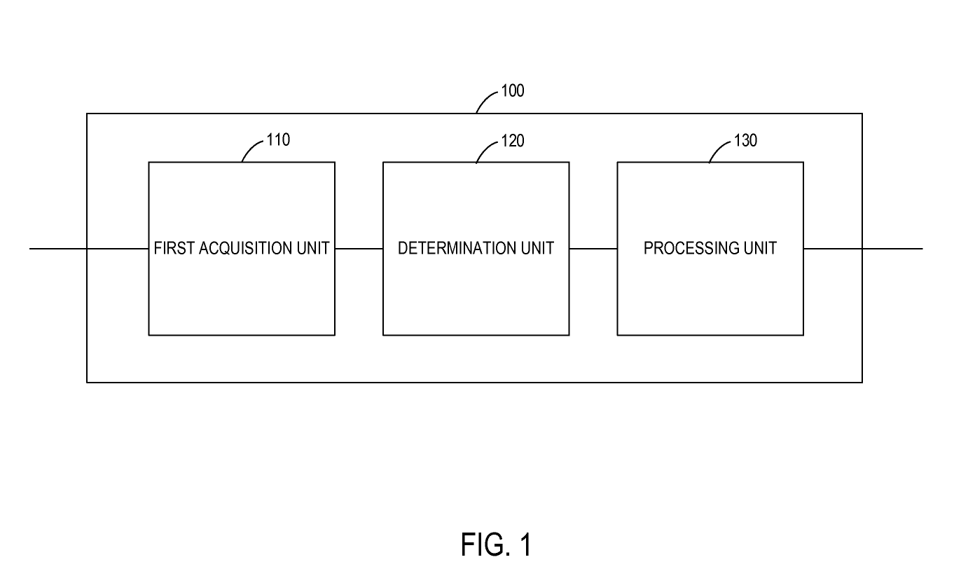

FIG. 1 illustrates a file reading protection system 100, in accordance with one embodiment of the present disclosure. As shown in FIG. 1, the file reading protection system 100 includes a first acquisition unit 110, a determination unit 120, and a processing unit 130.

As shown in FIG. 1, the first acquisition unit 110 in the file reading protection system 100 is configured to obtain a position of a user device when the user requests to access a digital file. In one embodiment, the digital file is encrypted by using a designated location related to the owner of the digital file. The person who requests to access the encrypted digital file and the person who encrypts the digital file are described as the user and the owner respectively for simplicity hereinafter.

More specifically, the owner is the person who encrypts the digital file. Usually, the person who encrypts the digital file can be the digital file's author or the digital file's owner. Moreover, in the embodiments according to the present disclosure, the digital file can be a document or a file, which includes words, images, audio, and/or video.

In addition, in the embodiments according to the present disclosure, the above-mentioned designated location can be set according to practical situation. For example, when the owner of the digital files gives a presentation in a meeting room, the designated location can be set such that a geographic area confine to a meeting room or a geographic coordinate of a device in the meeting room which is used to perform the presentation.

In one embodiment, the designated location for the owner of the digital file can be location designated by the owner of the digital file. More specifically, the above-mentioned designated location may include at least one geographic coordinate and/or at least one geographic area. In this situation, the owner can encrypt the digital file by using the designated location (e.g., a geographic coordinate of a device in an office room and/or a geographic area confine to the office room), the digital file can be encrypted by the owner or by using file encryption tools using the designated location related to a geographical position of the owner of the digital file, for example, a geographical coordinate of the owner's device, etc., the designated location may be store previously in a medium (not shown in FIG. 1) or be entered by the owner when the owner encrypts the digital file. The method for encrypting the digital file is well known by one of ordinary skill in the art, and will be not described herein for brevity and clarity. Then, the encrypted digital file can be uploaded to the network (e.g. Internet or Ethernet) and downloaded by other people, for example, colleagues, co-workers, etc.

In operation, a photo may be copied from an owner's computer to a user device (e.g., a user's mobile phone) by the owner. For example, the photo may be copied from the owner's device (e.g., U-disk or removable disk) to the user device which is used by the user to request to access the digital file. In this situation, the designated location related to the owner of the digital file may include a current position of the owner when the owner copies the photo to the user device. If the owner copies the photo to a user's computer in a meeting place, the designated location may be a geographic location of the owner when the owner copies the photo from the owner's device to the user device, e.g., a geographic coordinate of the owner or a geographic area confine to the meeting place. In this example, the first acquisition unit 110 in the file reading protection system 100 can be integrated in the user device, and can be equipped with a GPS positioning module. The GPS positioning module is configured to determine the position of the user device. As the owner and the user device are in the same place, the GPS positioning module can further determines the current position of the owner when the owner copies the photo to the user device. After the photo is encrypted according to the current position of the owner, the photo can be accessed by the user when the user and the owner both are in the meeting place, otherwise the photo cannot be assessed.

In one embodiment, if the user device is an internet-connected computer, the first acquisition unit 110 can obtain the position of the user device via the IP address location of the internet-connected computer. The geographic location of the internet-connected computer is obtained according to the IP address of the user device. The technology of IP address location is well known by one of ordinary skill in the art, and will be not described herein for brevity and clarity.

It should be understood by one of ordinary skill in the art that the position of the user device can be obtained in other ways, and will be not described herein for brevity and clarity.

As shown in FIG. 1, the determination unit 120 is configured to determine if the position of user device obtained by the first acquisition unit 110 satisfies a predetermined location for the user device related to the designated location disclosed above. The predetermined location for the user device can be set according to the practical condition. For example, the predetermined location for the user device can be set according to the actual coordinate of the designated location, e.g. GPS coordinate, etc. When the designated location includes several geographic coordinates, e.g. the geographic coordinate of the owner, the geographic coordinate of a device in a meeting place, etc, the predetermined location for the user device may be set such that the user device is one of the geographic coordinates.

In one embodiment, the predetermined location for the user device can be set such that the position of the user device is included in the designated location. That is, the determination unit 120 can determine if the position of the user device is included in the designated location. In the situation that the designated location includes at least one geographic coordinate, the determination unit 120 determines if the position of the user device is one of the geographic coordinates. In a situation that the designated location includes at least one geographic area, e.g. the geographic area confine to an office room, the geographic area confine to a meeting place, etc., the determination unit 120 determines if the position of the user device is within one of the geographic areas.

In another embodiment, the predetermined location for the user device can be set such that the position of the user device is within a predefined range of the designated location. That is, the determination unit 120 can determine if the position of the user device is within the predefined range of the designated location. When the designated location includes at least one geographic coordinate, the determination unit 120 determines if the position of the user device is within the predefined range of one of the geographic coordinates. It should be understood that the predefined range can be adjusted.

As shown in FIG. 1, the processing unit 130 is configured to determine if the digital file can be accessed and read by the user according to a determination result from the determination unit 120. In one embodiment, the processing unit 130 is configured to allow the user to access the digital file if the position of the user device satisfies the predetermined location for the user device, and disallow the user's access to the digital file if the position of the user device fails to satisfy the predetermined location for the user device.

It should be understood that the units and/or sub-units in the file reading protection system 100 can be integrated into one apparatus or different apparatuses.

The file reading protection system 100 shown in FIG. 1 includes the first acquisition unit 110, the determination unit 120, and the processing unit 130. In one embodiment, the first acquisition unit 110 can be integrated into a user device and equipped with a GPS positioning module. For example, a user A downloads an encrypted digital file F from internet, and stores the encrypted digital file F in the user device. The encrypted digital file F is encrypted by using the designated location by the owner who owns the digital file F. In one embodiment, the designated location may include three geographic coordinates, for example, P1, P2, and P3.

When the user A wants to access the encrypted digital file F, the user enters an instruction using an input device (e.g., a mouse and/or a keyboard) and the first acquisition unit 110 obtains a position P_{D} of a user device D using the GPS positioning module. The user device D is the device used by the user A to request to access the encrypted digital file F, and the position P_{D} can be used as the position of the user device.

After obtaining the position P_{D} of the user device D, the determination unit 120 can determine if the position P_{D} satisfies the predetermined location for the user device, that is, if the position P_{D} is within the predefined range of one of the geographic coordinates P1, P2, and P3. For example, the determination unit 120 determines if the position P_{D} is within 100 meters range of one of the geographic coordinates P1, P2, and P3.

For example, if the position P_{D} is within 100 meters range of any geographic coordinate, for example, P2, the processing unit 130 accepts the request from the user A and allows the user A to access the encrypted digital file F. Otherwise, if the position P_{D} is not within the 100 meters range of any geographic coordinate, the processing unit 130 disallows the request from the user A, and disallows the user A's access to the encrypted digital file F.

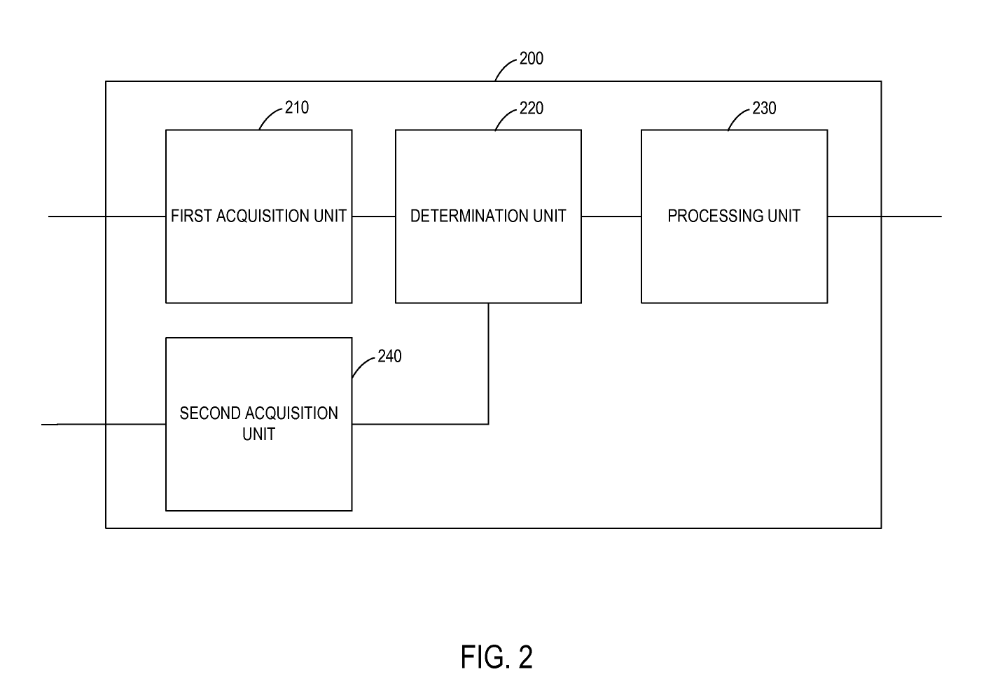

FIG. 2 illustrates another example of a file reading protection system 200, in accordance with one embodiment of the present disclosure. As shown in FIG. 2, the file reading protection system 200 includes a first acquisition unit 210, a determination unit 220, a processing unit 230, and a second acquisition unit 240. The first acquisition unit 210 can obtain the position of the user device, and the operation of the first acquisition unit 210 is the same as the operation of the first acquisition unit 110 shown in FIG. 1; hence, repetitive descriptions are omitted herein for purposes of brevity and clarity. The second acquisition unit 240 is configured to obtain the current position of the owner of a digital file when a user requests to access the digital file. The method for obtaining the current position of the owner of the digital file owner will be illustrated as following.

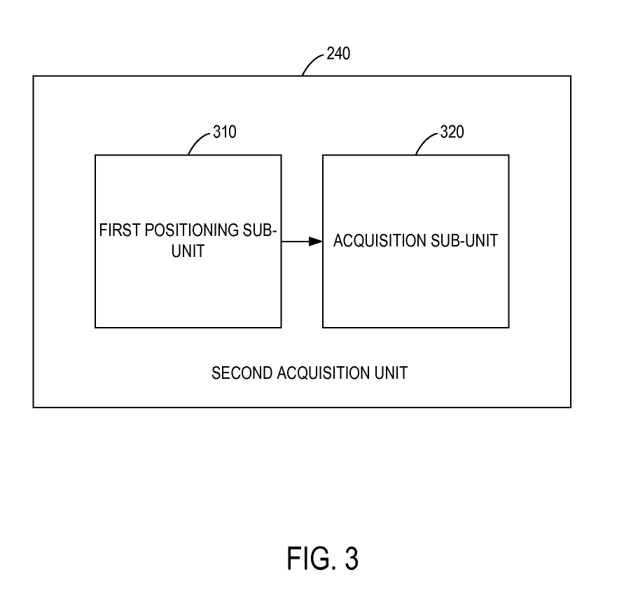

FIG. 3 shows a detailed block diagram of the second acquisition unit 240 in FIG. 2. As shown in FIG. 3, the second acquisition unit 240 includes a first positioning sub-unit 310 and an acquisition sub-unit 320. The first positioning sub-unit 310 determines the current position of the owner of the digital file, and may be, but not limited to, and is carried by the owner of the digital file. For example, the first positioning sub-unit 310 can be encapsulated and carried by the owner of the digital file. The first positioning sub-unit 310 can also be integrated in a mobile device which is carried by the owner of the digital file. The functions of the acquisition sub-unit 320 can be integrated in a separate device, for example, a user device, instead of being integrated together with the first positioning sub-unit 310. For example, the first positioning sub-unit 310 can be integrated in a GPS positioning module in the owner's mobile device. Then, the current position of the owner of the digital file can be obtained by a predetermined method which will be disclosed below.

In one embodiment, the acquisition sub-unit 320 obtains the current position of the owner of the digital file from the first positioning sub-unit 310 when the user requests to access the digital file. The acquisition sub-unit 320 communicates with the first positioning sub-unit 310 via wireless communication or wired connection, etc.

In one embodiment, determination of the current position of the owner of the digital file can be done according to practical conditions and/or requirements. For example, the first positioning sub-unit 310 can determine the current position of the owner of the digital file. Specifically, the first positioning sub-unit 310 can determine the position of the owner at different time, and store the newly determined position. In other word, the current position can be updated by replacing the previous position with the newly determined position. In another embodiment, the first positioning sub-unit 310 can store the current position of the owner of the digital file which is obtained periodically, e.g., every 10 minutes. In addition, the first positioning sub-unit 310 can upload the current position determined periodically to a web server and store the current position into the web server. Then, the acquisition sub-unit 320 downloads a position of the owner of the digital file which is used as the current position from the web server. So that the acquisition sub-unit 320 obtains the current position from the first positioning sub-unit 310 indirectly.

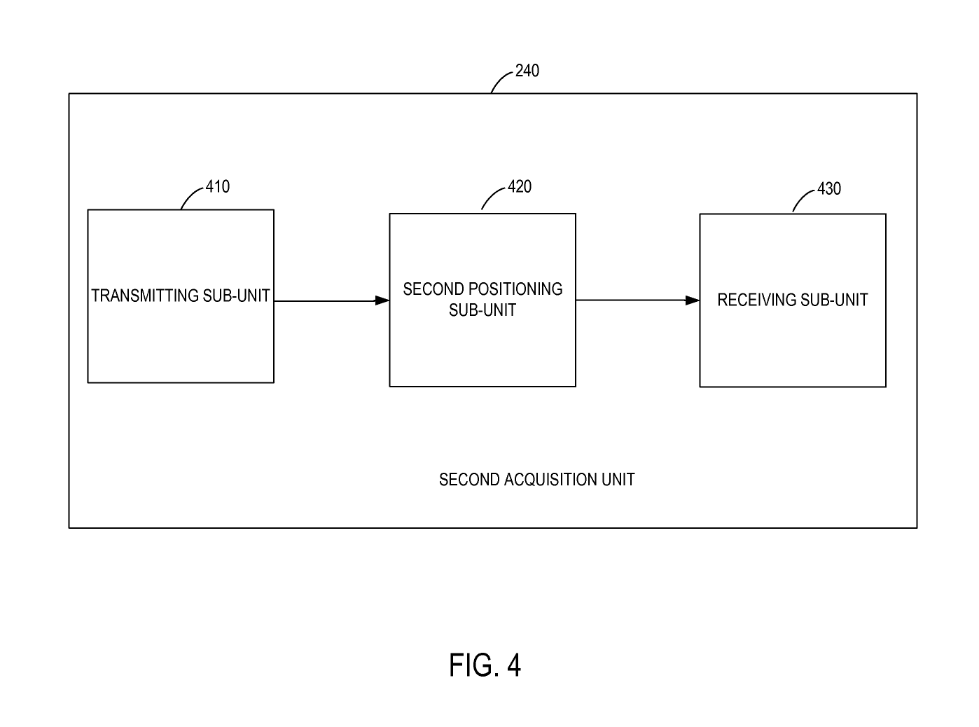

FIG. 4 shows another detailed block diagram of the second acquisition unit 240 in FIG. 2. As shown in FIG. 4, the second acquisition unit 240 includes a transmitting sub-unit 410, a second positioning sub-unit 420, and a receiving sub-unit 430. Similarly with the first positioning sub-unit 310 shown in FIG. 3, the second positioning sub-unit 420 determines the current position of the owner of the digital file, and which is carried by the owner of the digital file. For example, the second positioning sub-unit 420 can be encapsulated into an independent unit and be carried by the owner of the digital file. The second positioning sub-unit 420 can also be integrated into a mobile device carried by the owner of the digital file. In addition, the functions of the transmitting sub-unit 410 and the receiving sub-unit 430 can be integrated in a separate device, for example, a user device, and is carried by the user, instead of being integrated together with the second positioning sub-unit 420.

In one embodiment, the transmitting sub-unit 410 transmits a positioning instruction to the second positioning sub-unit 420 when a user requests to read a digital file. After receiving the positioning instruction from the transmitting sub-unit 410, the second positioning sub-unit 420 locates the owner of the digital file to obtain the current position of the owner of the digital file, and transmits the current position to the receiving sub-unit 430. As the second positioning sub-unit 420 can be integrated in a GPS positioning module in the owner's mobile device, for example, a phone, the current position of the owner of the digital file can be determined according to the GPS positioning module in the second positioning sub-unit 420, the receiving sub-unit 430 can receive the current position of the owner of the digital file from the second positioning sub-unit 420. Moreover, the transmitting sub-unit 410 and the receiving sub-unit 430 communicate with the second positioning sub-unit 420 via wireless communication or wired connection, etc.

Referring back to FIG. 2, after the first acquisition unit 210 obtains the position of the user device and the second acquisition unit 240 obtains the current position of the owner of the digital file, the determination unit 220 determines the positions obtained from the first acquisition unit 210 and the second acquisition unit 240 and generates a determination result, and then the processing unit 230 determines if the user can access and read the digital file according to the determination result. Specifically, the determination unit 220 determines if the position of the user device and the current position of the owner of the digital file satisfy a predetermined location for the user device and a predetermined location for the owner of the digital file, respectively. In one embodiment, the predetermined location for the user device is related to a designated location, i.e., the designated location related to the owner of the digital file. The designated location can be set according to practical situation. For example, when the owner of the digital files gives a presentation in a meeting room, the designated location can be set such that a geographic area confine to a meeting room or a geographic coordinate of a device in the meeting room which is used to perform the presentation.

In addition, the predetermined location for the user device herein is the same as the predetermined location for the user device determined by the determination unit 120. More specifically, in one embodiment, the predetermined location for the user device can be set such that the position of the user device is included in the designated location. That is, the determination unit 220 can determine if the position of the user device is included in the designated location. When the designated location includes at least one geographic coordinate and/or at least one geographic area, the determination unit 220 determines if the position of the user device is within either one of the geographic coordinates and/or one of the geographic areas. In another embodiment, the predetermined location for the user device can be set such that the position of the user device when the user requests to access the digital file is within a predefined range of the designated location. That is, the determination unit 120 can determine if the position of the user device is within the predefined range of the designated location. When the designated location includes at least one geographic coordinates, the determination unit 120 determines if the position of the user device is within the predefined range of one of the geographic coordinates. It should be understood that the predefined range can be set according to experience or practice.

Moreover, the predetermined location for the owner of the digital file can be set according to practical situation, for example, according to the actual coordinate of the designated location, e.g. GPS coordinate.

In one embodiment, the predetermined location for the owner of the digital file can be set such that the current position of the owner of the digital file when the user requests to access the digital file is included in the designated location. That is, besides determining if the position of the user device satisfies with the predetermined location for the user device, the determination unit 220 further determines if the current position of the owner is included in the designated location. For example, when the designated location includes multiple geographic coordinates, e.g. geographic coordinates P1, P2, and P3, the determination unit 220 determines if the current position of the owner of the digital file coincides with one of the geographic coordinates. In another situation when the designated location includes at least one geographic area, e.g., a geographic area confine to an office room, etc., the determination unit 220 determines if the current position is within one of the geographic areas.

In another embodiment, the predetermined location for the owner of the digital file can be set such that the current position of the owner of the digital file is within a predefined range of the designated location. In other words, besides determining if the position of the user device satisfies the predetermined location for the user device, the determination unit 220 further determines if the current position of the owner is within the predefined range of the designated location.

The processing unit 230 in the file reading protection system 200 is configured to allow the user to access and read the digital file when the position of the user device satisfies the predetermined location for the user device and the current position of the owner satisfies the predetermined location for the owner of the digital file, and disallow the user's access to the encrypted digital file when the position of the user device fails to satisfy the predetermined location for the user device and/or the current position of the owner fails to satisfy the predetermined location for the owner of the digital file.

For example, when a user A′ copies a source file Fₛ from a predetermined device Dₛ belonging to owner B′ who created the source file Fₛ to the user device D′, the source file Fₛ can be encrypted automatically based on a position P′1. Thus an encrypted digital file F′ is generated and stored on the user device D′. The position P′1 is the position of the owner B′ when the user A′ copies the source file Fₛ and the encrypted digital file F′ is generated. In this example, the first acquisition unit 210 is integrated in the user's device D′, and equipped with a GPS positioning module.

If the user A′ requests to access the digital file F′ by entering a command through a mouse and/or a keyboard, etc., the first acquisition unit 210 can determine a position P_{D}′ of the user device D′ by the GPS positioning module in the first acquisition unit 210.

In addition, when the user A′ accesses the digital file F′, the second acquisition unit 240 obtains the current position P_{F}′ of the owner B′ who owns the digital file F′. The current position P_{F}′ can be a specific position in a meeting place.

After obtaining the first position P_{D}′ of the user device D′ and the current position P_{F}′ of the owner B′, the determination unit 220 determines if the first position P_{D}′ of the user device D′ and the current position P_{F}′ of the owner B′ satisfies the predetermined location for the user device and the predetermined location for the owner of the digital file, respectively. For example, the determination unit 220 determines if the first position P_{D}′ and the current position P_{F}′ are within a first predefined range of the position P′1 and within a second predefined range of the position P′1, respectively, e.g., the determination unit 220 determines if the first position P_{D}′ of the user device D′ is within a 100 meters range of the predetermined position P′1 and the current position P_{F}′ of the owner B′ is within the a 100 meters range of the predetermined position P′1. In this situation, the first predefined range and the second predefined range are both the 100 meters range. In one embodiment, the 100 meter range of the position P′1 may be the area confine to the meeting place. It should be understood that the first predefined range and the second predefined range can be other shapes, for example, a square area or a rectangle area with the position P′1 as a center, and the length and width may be set previously by the owner, and it is not limited to a circular range.

In one embodiment, if the first position P_{D}′ of the user device D′ is within the 100 meters range of 100 of the predetermined position P′1 and the current position P_{F}′ of the owner B′ who owns the digital file F′ is within the 100 meters range of the predetermined position P′1, the processing unit 230 accepts the request from the user A′ and allows the user A′ to access the digital file F′. When the user A′ and the owner B′ are both around the predetermined position P′1, for example, both the user A′ and the owner B′ are in the same meeting. Thus, the processing unit 230 allows the user A′ to access the digital file F′. In another situation, if the first position P_{D}′ of the user device D′ is out of the 100 meters range of the predetermined position P′1 and/or the current position P_{F}′ of the owner B′ is out of the100 meters range of the predetermined position P′1, the processing unit 230 disallows the request from the user A′ and disallows the user A′ to access the digital file F′. In this case, the request of reading the digital file F′ is disallowed if any of the user A′ or the owner B′ is not around the predetermined position P′1. For example, if either the user A′ or the owner B′ is not at the meeting, the processing unit 230 disallows the user A′ to access the digital file F′.

Accordingly, if the owner B′ copies the source file Fₛ to a user device D′, only when the owner B′ and the user device D′ both are in the same meeting place or within a range of the same meeting place, the user A′ can access the digital file F′ in the user device D′. In one embodiment, the digital file F′ is generated by encrypting the source file Fₛ. In other words, when the owner B′ leaves the meeting place or is out of the predefined range of the meeting place, the digital file F′ cannot be accessed from the user device D′. In addition, when the user device D′ is out of the meeting room or is out of a predefined range of the meeting place, the digital file F′ cannot be accessed from the user device D′. Therefore, the digital file F′ can be protected from being read when the digital file F′ is not in the designated location.

As disclosed above, the file reading protection system according to embodiments of the present invention can determine if an encrypted digital file is allowed to be accessed by a user based on position determination, therefore, the encrypted digital file cannot be used or accessed by any user without permission, and the digital file can be protected from being used by users who are not authorized.

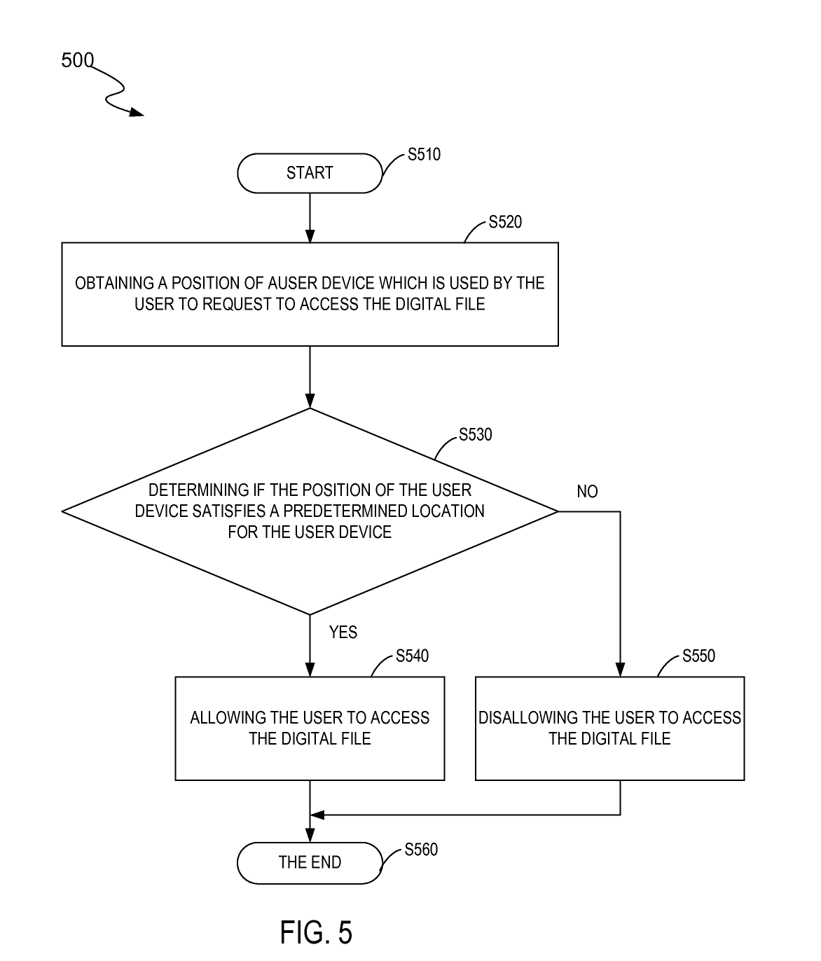

FIG. 5 illustrates a flowchart 500 illustrating an exemplary method for performing file reading protection, in accordance with one embodiment of the present disclosure. FIG. 5 will be described in combination with FIG. 1.

The method starts at step S510. After a user requests to access a digital file, the first acquisition unit 110 in a file reading protection system 100 obtains the position of the user device which is used by the user to request to access the digital file, step S520, wherein the digital file is generated by encrypting a source digital file by the owner using designated location related to the owner of the digital file before the user requests to access the digital file. For example, the digital file can be encrypted by the owner or using a file encryption tools using the designated location. In addition, the designated location is described in detail above; hence, repetitive descriptions are omitted herein for purposes of brevity and clarity.

Then, the flowchart 500 goes to step S530. The determination unit 120 in the file reading protection system 100 determines if the position of the user device satisfies a predetermined location for the user device, step S530. In one embodiment, the predetermined location for the user device is related to the designated location. For example, the predetermined location for the user device can be set such that the position of the user device is included in the designated location. That is, the determination unit 120 can determine if the position of the user device is included in the designated location. When the designated location includes at least one geographic coordinate and/or at least one geographic area, for example, a geographic coordinate of a device in a meeting room and/or a geographic area confine to the meeting room, etc, the determination unit 120 determines if the position of the user device is within either one of the geographic coordinates and/or one of the geographic areas.

If the position of the user device satisfies the predetermined location for the user device, a processing unit 130 in the file reading protection system 100 allows the user to access the digital file, as shown at step S540. Otherwise, the processing unit 130 in the file reading protection system 100 disallows the user's request to access the encrypted digital file, as shown at step S550.

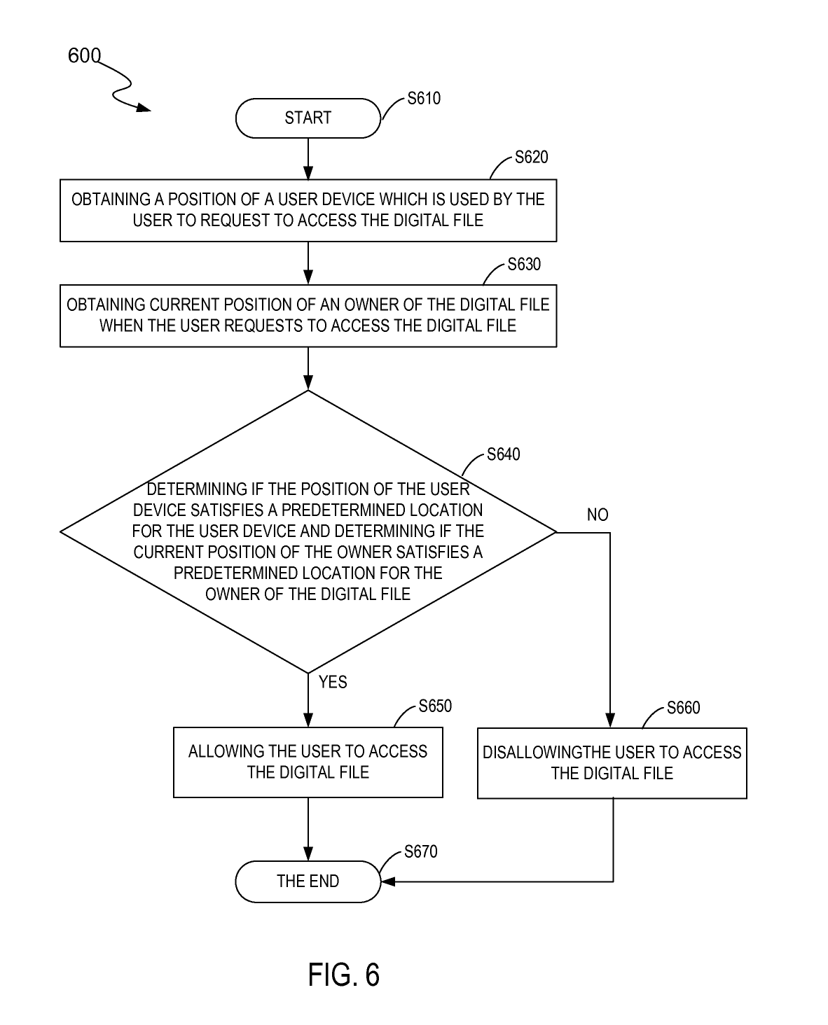

FIG. 6 illustrates a flowchart illustrating another exemplary embodiment of a method for performing file reading protection, in accordance with one embodiment of the present disclosure. FIG. 6 is described in combination with FIG. 2. As shown in FIG. 6, the method disclosed in this embodiment includes the steps of S610-S670.

The flowchart 600 starts at step S610. After a user requests to access a digital file, the first acquisition unit 210 in a file reading protection system 200 obtains position of the user device which is used by the user to request to access the digital file, step S620, wherein the digital file is generated by encrypting a source digital file using designated location related to the owner of the digital file before the user requests to access the digital file. For example, the digital file can be encrypted by the owner or using a file encryption tools using the designated location.

Then, a second acquisition unit 240 obtains current position of the owner of the digital file when the user requests to access the digital file, step S630.

After obtaining the position of the user device and the current position of the owner, a determination unit 220 in the file reading protection system 200 determines if the position of the user device satisfies a predetermined location for the user device and further determines if the current position of the owner satisfies a predetermined location for the owner of the digital file, step S640. In one embodiment, both the predetermined location for the user device and the predetermined location for the owner of the digital file are related to the designated location. For example, the predetermined location for the user device can be set such that the position of the user device is included in the designated location. When the designated location includes at least one geographic coordinate and/or at least one geographic area, the determination unit 220 determines if the position of the user device is within one of the geographic coordinates and/or one of the geographic areas. In addition, the predetermined location for the owner of the digital file can be set such that the current position of the owner of the digital file is included in the designated location. That is, besides determining if the position of the user device satisfies the predetermined location for the user device, the determination unit 220 further determines if the current position of the owner is included in the designated location. For example, when the designated location includes at least one geographic coordinate, the determination unit 220 determines if the current position of the owner of the digital file coincides with one of the geographic coordinates. When the designated location includes at least one geographic area, the determination unit 220 determines if the current position is within one of the geographic areas.

If the position of the user device satisfies the predetermined location for the user device and the current position of the owner satisfies the predetermined location for the owner of the digital file, a processing unit 230 in the file reading protection system 200 allows the user to access the digital file, at step S650.

Otherwise, if the position of the user device fails to satisfy the predetermined location for the user device and/or the current position of the owner fails to satisfy the predetermined location for the owner of the digital file, the processing unit 230 in the file reading protection system 200 disallows the user to access the digital file, at step S660.

As disclosed above, the file reading protection system can determine if a digital file is allowed to access by detecting positions, in accordance with one embodiment of the present disclosure, then, the digital file can be protected from being used by users who are not authorized.

In another embodiment, an information processing apparatus is provided, in accordance with one embodiment of the present disclosure. The information processing apparatus can be integrated with a file reading protection system above mentioned. The information processing apparatus can be a device, for example, a computer, phone, iPad™, or PDA (Personal Digital Assistant), etc. Specifically, the units and sub-units in the file reading protection system can be configured by software package, firmware, hardware, or a combination by combining any these three components.

While the foregoing description and drawings represent embodiments of the present disclosure, it will be understood that various additions, modifications, and substitutions may be made therein without departing from the spirit and scope of the principles of the present disclosure as defined in the accompanying claims. One skilled in the art will appreciate that the present disclosure may be used with many modifications of form, structure, arrangement, proportions, materials, elements, and components and otherwise, used in the practice of the disclosure, which are particularly adapted to specific environments and operative requirements without departing from the principles of the present disclosure. The presently disclosed embodiments are therefore to be considered in all respects as illustrative and not restrictive, the scope of the present disclosure being indicated by the appended claims and their legal equivalents, and not limited to the foregoing description.

We claim:

1. A file reading protection system, comprising:
a first acquisition unit configured to obtain a first position of a user device that requests to access a digital file;
a determination unit configured to determine if the first position obtained by the first acquisition unit satisfies a first predetermined condition related to the predetermined position information and to generate a determination result according determination; and
a processing unit configured to determine if the user is allowed to access the digital file according to the determination result.

2. The file reading protection system of claim 1, wherein the predetermined position information comprises position information designated by the owner of the digital file.

3. The file reading protection system of claim 1, wherein the predetermined position information comprises a position of the owner of the digital file when the digital file is copied to the user device.

4. The file reading protection system of claim 1, wherein the first predetermined condition is set such that the first position is included in the predetermined position information.

5. The file reading protection system of claim 1, wherein the first predetermined condition is set such that the first position is within a first predefined range of the predetermined position in the predetermined position information.

6. The file reading protection system of claim 1, further comprises:
a processing unit configured to allow the user to access the digital file if the first position satisfies the first predetermined condition, wherein the processing unit disallows the user to access the digital file if the first position fails to satisfy the first predetermined condition.

7. The file reading protection system of claim 1, further comprises:
a second acquisition unit configured to obtain a second position of the owner of the digital file when the user requests to access the digital file, wherein the determination unit further configured to determines if the second position of the owner of the digital file satisfies a second predetermined condition related to the predetermined position information.

8. The file reading protection system of claim 7, wherein the second acquisition unit further comprises:
a first positioning sub-unit configured to determine the second position of the owner of the digital file; and
an acquisition sub-unit configured to obtain the second position of the owner of the digital file from the first positioning sub-unit when the user requests to access the digital file.

9. The file reading protection system of claim 7, wherein the second acquisition unit further comprises:
a transmitting sub-unit configured to transmit a positioning instruction;
a second positioning sub-unit configured to determine the second position of the owner of the digital file after receiving the positioning instruction from the transmitting sub-unit; and
a receiving sub-unit configured to receive the second position of the owner of the digital file from the second positioning sub-unit.

10. The file reading protection system of claim 7, wherein the second predetermined condition is set such that the second position of the owner of the digital file is included in the predetermined position information, or the second predetermined condition is set such that second position of the owner of the digital file is within a second predefined range of the predetermined position in the predetermined position information.

11. The file reading protection system of claim 7, further comprising:
the processing unit configured to allow the user to access the digital file if the first position satisfies the first predetermined condition and the second position of the owner of the digital file satisfies the second predetermined condition, wherein the processing unit configured to disallow the user to access the digital file if the first position fails satisfied the first predetermined condition and/or the second position of the owner of the digital file fails to satisfy the second predetermined condition.

12. A method for performing file reading protection, comprising the steps of:
obtaining first position of a user device that requests to access a digital file by a first acquisition unit;
determining if the first position obtained by the first acquisition unit satisfies a first predetermined condition related to the predetermined position information by a determination unit, and generating a determination result according determination; and
determining if the user is allowed to read the digital file according to the determination result by a processing unit.

13. The method for performing file reading protection of claim 12, wherein predetermined position information comprises position information designated by the owner of the digital file.

14. The method for performing file reading protection of claim 12, wherein the predetermined position information comprises a position of the owner of the digital file when the digital file is copied to the user device.

15. The method for performing file reading protection of claim 12, wherein the first predetermined condition is set such that the first position is included in the predetermined position information.

16. The method for performing file reading protection of claim 12, wherein the first predetermined condition is set such that the first position is within a first predefined range of the predetermined position in the predetermined position information.

17. The method for performing file reading protection of claim 12, further comprising:
allowing the user to access the digital file if the first position satisfies the first predetermined condition, wherein the processing unit disallows the user to access the digital file if the first position fails to satisfy the first predetermined condition.

18. The method for performing file reading protection of claim 12, further comprising:
obtaining a second position of the owner of the digital file when the user requests to access the digital file by a second acquisition unit, wherein the determination unit further configured to determines if the second position of the owner of the digital file satisfies a second predetermined condition related to the predetermined position information.

19. The method for performing file reading protection of claim 18, further comprising:
determining the second position of the owner of the digital file by a first positioning sub-unit in the second acquisition unit; and
obtaining the second position of the owner of the digital file from the first positioning sub-unit when the user requests to access the digital file by an acquisition sub-unit in the second acquisition unit.

20. The method for performing file reading protection of claim 18, further comprising:
transmitting a positioning instruction by a transmitting sub-unit;
determining the second position of the owner of the digital file after receiving the positioning instruction from the transmitting sub-unit by a second positioning sub-unit; and
receiving the second position of the owner of the digital file from the second positioning sub-unit by a receiving sub-unit.

21. The method for performing file reading protection of claim 18, wherein the second predetermined condition is set such that the second position of the owner of the digital file is included in the predetermined position information, or the second predetermined condition is set such that the second position of the owner of the digital file is within a second predefined range of the predetermined position in the predetermined position information.

22. The method for performing file reading protection of claim 18, further comprising:
allowing the user to access the digital file if the first position satisfies the first predetermined condition and the second position of the owner of the digital file satisfies the second predetermined condition, wherein the processing unit disallows the user to access the digital file if the first position fails satisfied the first predetermined condition and/or the second position of the owner of the digital file fails to satisfy the second predetermined condition.
